(19) United States
(12) Patent Application Publication
(10) Pub. No.: US 2007/0002575 A1
(43) Pub. Date: Jan. 4, 2007

(54) Self-sufficient energy lighting device

(76) Inventor: Han-Chung Chiang, Chungho City (TW)

Correspondence Address: PATENTTM.US, P. O. BOX 82788, PORTLAND, OR, 97282-0788, US

(21) Appl. No.: 11/174,127

(22) Filed: Jun. 30, 2005

(51) Int. Cl. B60Q 1/26

(52) U.S. Cl. 362/500

(57) ABSTRACT

A self-sufficient energy lighting device is mounted on a vehicle wheel hub and has a first disk, a pivot pin, a second disk, a nut and hubcap. The first disk is attached securely to the wheel hub has at least one magnet. The pivot pin extends out through the first disk. The second disk is rotatably mounted on the pivot pin and has at least one coil and at least one lighting element electrically connected to the coil. When the vehicle runs and turns the wheel hub and first disk, the second disk rotates relative to the first disk and causes the lighting element to shine.

### BACKGROUND OF THE INVENTION

1. Field of the Invention

The present invention relates to a lighting device, and more particularly to a self-sufficient energy lighting device that is mounted on a rotating wheel of a vehicle without an external power source.

2. Description of Related Art

Most vehicles intended for street use must have headlights, taillights and turn signals mounted on the front and rear of vehicles so that the lights and signals shine and warn people nearby.

To conserve electrical energy and hold down production costs, sides of automobiles and other vehicles often have no lights so people have difficulty seeing those vehicles from their sides at night, which causes a potentially hazardous condition to exist.

To overcome the shortcomings, the present invention provides a self-sufficient energy lighting device to mitigate or obviate the aforementioned problems.

### SUMMARY OF THE INVENTION

The main objective of the invention is to provide a self-sufficient energy lighting device that is mounted on a wheel of a vehicle and shines without an external power source when the wheel rotates.

A self-sufficient energy lighting device in accordance with the present invention is mounted on a vehicle wheel hub and comprises a first disk, a pivot pin, a second disk, a nut and a hubcap.

The first disk is attached securely to the wheel hub and has at least one magnet.

The pivot pin extends out through the first disk.

The second disk is rotatably mounted on the pivot pin and has at least one coil and at least one lighting element electrically connected to the coil.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a self-sufficient energy lighting device in accordance with the present invention;

FIG. 2 is a side view in partial section of the self-sufficient energy lighting device in FIG. 1; and

FIG. 3 is a circuit diagram of the self-sufficient energy lighting device in FIG. 1.

### DETAILED DESCRIPTION OF PREFERRED EMBODIMENT

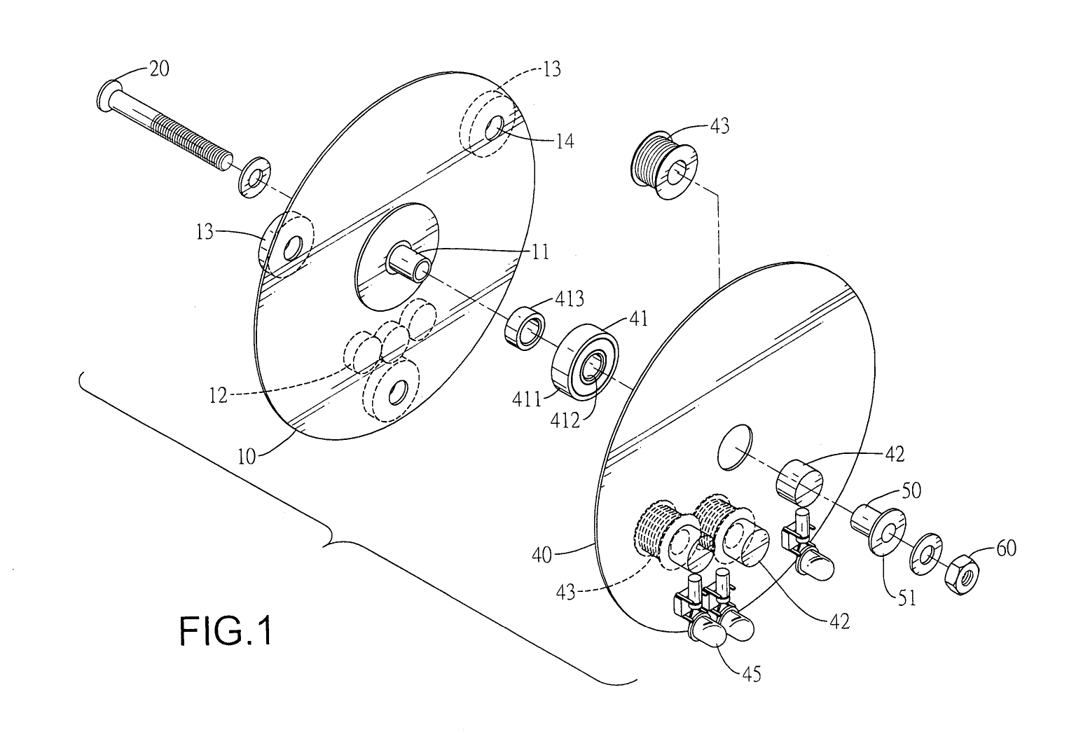

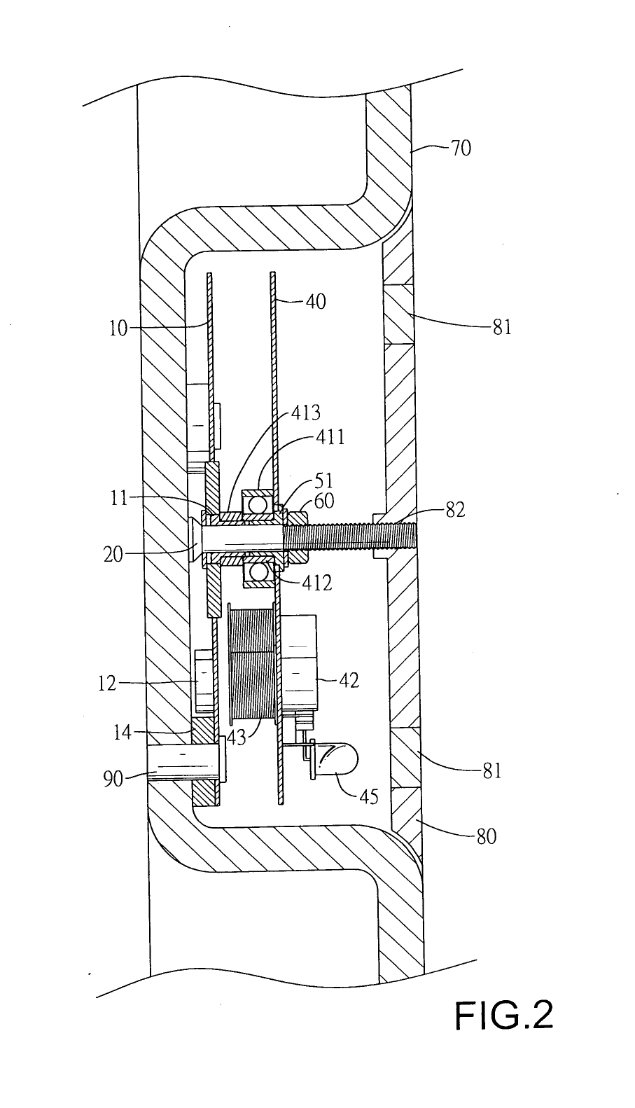

With reference FIGS. 1 and 2, a self-sufficient energy lighting device in accordance with the present invention is mounted securely on a wheel hub (70). The wheel hub (70) is mounted on a vehicle and has multiple threaded holes defined through the wheel hub (70).

The self-sufficient energy lighting device comprises a first disk (10), a pivot pin (20), a second disk (40), a mounting sleeve (50), a nut (60) and a hubcap (80).

The first disk (10) is attached securely to the wheel hub (70) and has an outer surface, an inner surface, an axis, multiple mounting holes (14), multiple resilient gaskets (13), a central sleeve (11) and at least one magnet (12). The mounting holes (14) are defined through the first disk (10) and correspond to the threaded holes in the wheel hub (70). The first disk (10) is attached to the wheel hub (70) by multiple fasteners (90) such as bolts extending respectively through the mounting holes (14) in the first disk (10) and screwing into the threaded holes in the wheel hub (70). The resilient gaskets (13) are mounted on the inner surface of the first disk (10) respectively around the mounting holes (14) and abut the wheel hub (70). The central sleeve (11) protrudes coaxially from the outer surface of the first disk (10). The at least one magnet (12) is mounted off-center on the inner surface or outer surface of the first disk (10) and has a north pole and a south pole such that the north and south poles of each magnet are in a line parallel to the axis of the first disk (10).

The pivot pin (20) extends through the central sleeve (11) on the first disk (10) and has a proximal end, a distal end, an enlarged head and an outer thread. The enlarged head is formed on the proximal end of the pivot pin (20) and abuts the inner surface of the first disk (10). The outer thread is formed on the pivot pin (20) at the distal end.

The second disk (40) is mounted rotatably around the pivot pin (20) and has an inner surface, an outer surface, a central hole, a bearing (41), at least one coil (43), at least one lighting element (45), at least one off-center weight (42) and a center of gravity.

The central hole is defined through the second disk (40) and is mounted around the pivot pin (20).

The bearing (41) is attached securely to the inner surface of the second disk (40) around the central hole in the second disk (40) and the central sleeve (11) on the first disk (10) and has an outer race (411), an inner race (412) and a spacer (413). The outer race (411) is attached securely to the inner surface of the second disk (40). The inner race (412) is mounted securely on the central sleeve (11) of the first disk (10), may be wider than the outer race (411) and may abut the first disk (10). The spacer (413) is mounted around the central sleeve (11) on the first disk (10) and has two ends respectively abutting the outer surface of the first disk (10) and the inner race (412) of the bearing (41).

The at least one coil (43) is mounted on the inner surface of the second disk (40), corresponds to the at least one magnet (12) on the first disk (10) and generates a current when the first disk (10) and the second disk (40) rotate relative to each other.

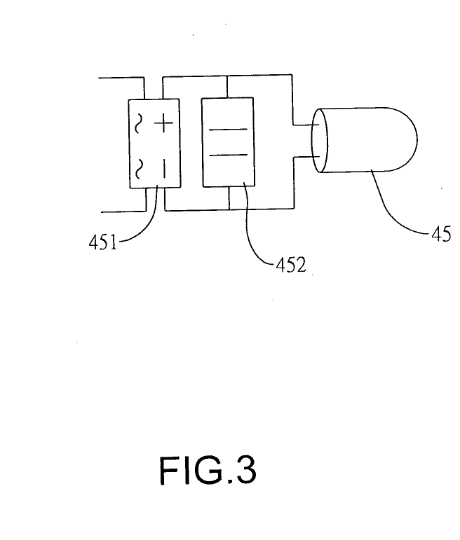

With further reference to FIG. 3, the at least one lighting element (45) is mounted on the outer surface of the second disk (40), is connected electrically to the at least one coil (43) and has a light and circuitry. The light may be a light emitting diode (LED) or an incandescent bulb. When the light is an LED, the circuitry comprises a rectifier (451) and a capacitor (452). The LED is connected electrically to the rectifier (451) and the capacitor (452). Current generated by the at least one coil (43) is rectified by the rectifier (451), is filtered by the capacitor (452) and is supplied to the LED.

The at least one off-center weight (42) is mounted off-center on the inner or outer surface of the second disk (40) to make the center of gravity of the second disk (40) off-center.

The center of gravity of the second disk (40) is off-center by mounting the at least one off-center weight (42) off-center or mounting the at least one coil (43) and the at least one lighting element (45) off-center on the second disk (40). The offset center of gravity holds the second disk (40) in position so it rotates relative to the first disk (10) when the vehicle moves and the wheel hub (70) and the first disk (10) rotate.

The mounting sleeve (50) is mounted through the central hole in the second disk (40) and in the inner race (412) of the bearing (41) around the pivot pin (20). The mounting sleeve (50) has an inner end, an outer end and an annular flange (51). The annular flange (51) is formed on and extends out from the outer end of the mounting sleeve (50) and presses against the front end of the inner race (412) of the bearing (41).

The nut (60) screws onto the pivot pin (20), tightly abuts the mounting sleeve (50) and has an inner thread corresponding to the outer thread of the pivot pin (20). With the nut (60) tightly abutting the mounting sleeve (50), the mounting sleeve (50), the inner race (412) and the spacer (413) of the bearing (41), the pivot pin (20) and the first disk (10) are held securely together and are rotatable relative to the outer race (411) of the bearing (41) and the second disk (40).

The hubcap (80) is mounted on the distal end of the pivot pin (20) and has an inner surface, at least one transparent section (81) and a central threaded hole (82). The at least one transparent section (81) is aligned radially with the lighting element (45) on the second disk (40) to allow the lighting element to be seen when the vehicle wheel rotates. The central threaded hole (82) defined coaxially in the inner surface of the hubcap (80) and screws onto the outer thread at the distal end of the pivot pin (20).

The at least one lighting element (45) shines when the vehicle runs so people on sides of the automobile can easily notice the automobile. Furthermore, the self-sufficient energy light device operates without any external power source and is energy efficient.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A self-sufficient energy lighting device adapted to be mounted on a wheel hub having multiple threaded holes defined through the wheel hub, the self-sufficient energy lighting device comprising:
a first disk adapted to be attached securely to the wheel hub and having
an outer surface;
an inner surface;
an axis;
multiple mounting holes defined through the first disk and adapted to correspond to the threaded holes in the wheel hub;
a central sleeve protruding coaxially from the outer surface of the first disk; and
at least one magnet mounted on the first disk and each having a north pole and a south pole;
a pivot pin extending through the central sleeve on the first disk and having
a proximal end;
a distal end; and
an enlarged head formed on the proximal end of the pivot pin and abutting the inner surface of the first disk; and
an outer thread formed on the pivot pin at the distal end;
a second disk mounted rotatably around the pivot pin and having
an inner surface;
an outer surface;
a central hole defined through the second disk and mounted around the pivot pin;
a bearing attached securely to the inner surface of the second disk around the central hole in the second disk and the central sleeve on the first disk and having
an outer race attached securely to the inner surface of the second disk; and
an inner race mounted securely on the central sleeve of the first disk;
at least one coil mounted on the inner surface of the second disk, corresponding to the at least one magnet on the first disk and generating a current when the first disk and the second disk rotate relative to each other;
at least one lighting element mounted on the outer surface of the second disk, connected electrically to the at least one coil and having a light and circuitry; and
a center of gravity being off-center;
a mounting sleeve mounted through the central hole in the second disk and in the inner race of the bearing around the pivot pin and having
two ends; and
an annular flange formed on the mounting sleeve and pressing against the front end of the inner race of the bearing;
a nut screwing onto the pivot pin, tightly abutting the mounting sleeve and having an inner thread corresponding to the outer thread of the pivot pin.

2. The self-sufficient energy lighting device as claimed in claim 1, wherein the bearing further has a spacer mounted around the central sleeve on the first disk and having two ends respectively abutting the outer surface of the first disk and the inner race of the bearing.

3. The self-sufficient energy lighting device as claimed in claim 2, wherein the light in the at least one light element is a light emitting diode and the circuitry comprises a rectifier and a capacitor.

4. The self-sufficient energy lighting device as claimed in claim 3, wherein the north and south poles of each magnet are in a line parallel to the axis of the first disk.

5. The self-sufficient energy lighting device as claimed in claim 4, wherein the second disk further has at least one off-center weight mounted off-center on the second disk.

6. The self-sufficient energy lighting device as claimed in claim 5, wherein the first disk further has multiple resilient gaskets mounted on the inner surface of the first disk respectively around the mounting holes in the first disk and adapted to abut the wheel hub.
